(19) United States
(12) Patent Application Publication
(10) Pub. No.: US 2013/0069764 A1
(43) Pub. Date: Mar. 21, 2013

(54) ELECTRONIC DEVICE AND MONITORING METHOD

(71) Applicant: CHING-CHUNG WU, Tu-Cheng (TW)

(72) Inventor: CHING-CHUNG WU, Tu-Cheng (TW)

(73) Assignee: HON HAI PRECISION INDUSTRY CO., LTD., Tu-Cheng (TW)

(21) Appl. No.: 13/450,496

(22) Filed: Apr. 19, 2012

(30) Foreign Application Priority Data
Sep. 16, 2011 (TW) 100133403

(51) Int. Cl. G06F 7/04; G06K 9/46

(52) U.S. Cl. 340/5.83; 382/118

(57) ABSTRACT

The present disclosure provides an electronic device and a method of monitoring the electronic device. When there is no user in the predetermined time period in the front of the electronic device, the electronic device is locked to avoid an illegal user from operating the electronic device. When there is one illegal user in the predetermined time period in the front of the electronic device, the electronic device is locked and notifies the legal user that another person is operating the electronic device. When there is one legal user in the predetermined time period in the front of the electronic device, the electronic device maintains the work state.

### BACKGROUND

1. Technical Field

The present disclosure relates to electronic devices and, particularly, to an electronic device and a method of monitoring the device.

2. Description of Related Art

In the course of utilizing an electronic device, a legal user may leave and forget to lock the electronic device. However, an illegal user may operate the electronic device to steal important information in the electronic device and the legal user cannot know who has operated the electronic device.

Therefore, what is needed is an electronic device and a method of monitoring the device to overcome the described limitations.

### BRIEF DESCRIPTION OF THE DRAWINGS

FIG. 1 is a block diagram of the hardware infrastructure of an electronic device, in accordance with an exemplary embodiment.

FIG. 2 is a block diagram of the processing unit of the electronic device of FIG. 1, in accordance with an exemplary embodiment.

FIG. 3 is a flowchart of a method of monitoring the electronic device of FIG. 1, in accordance with an exemplary embodiment.

### DETAILED DESCRIPTION

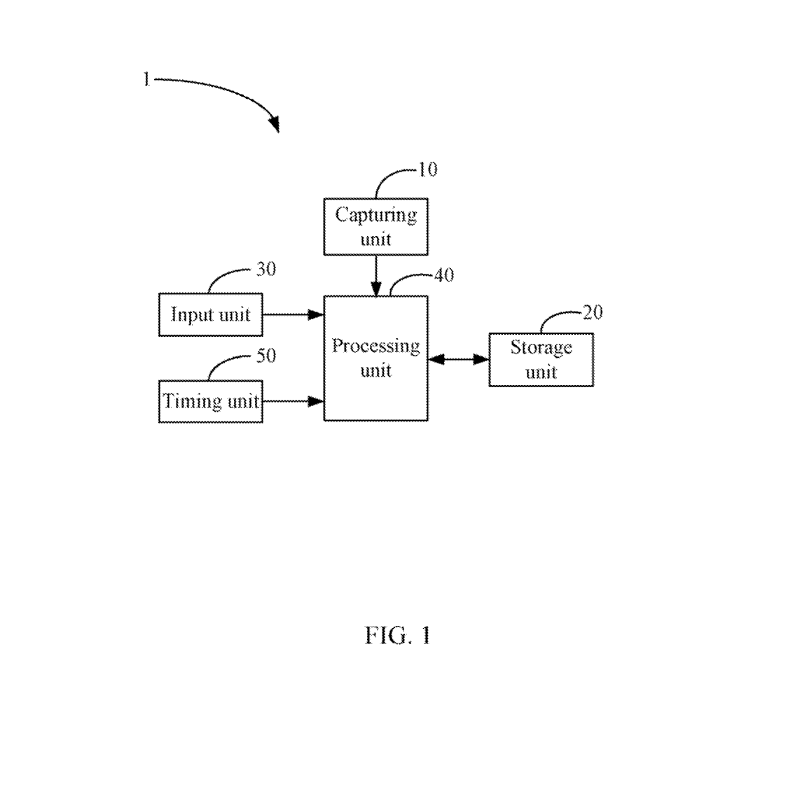

FIG. 1 is a block diagram of the hardware infrastructure of an electronic device, in accordance with an exemplary embodiment. The electronic device 1 may be a mobile phone, or a computer, for example. The electronic device 1 includes a capturing unit 10, a storage unit 20, an input unit 30, a processing unit 40, and a timing unit 50. The capturing unit 10 captures images. In one embodiment, the capturing unit 10 is a camera. The input unit 30 generates input instructions in response to an input of a user. The timing unit 50 starts measuring time for a predefined time period when the electronic device 1 enters a work state.

The storage unit 20 stores at least one facial image and a facial feature of the facial image. In one embodiment, the at least one facial image is the facial image of authorized users. The at least one facial image is obtained from an external device (not shown) or the capturing unit 10.

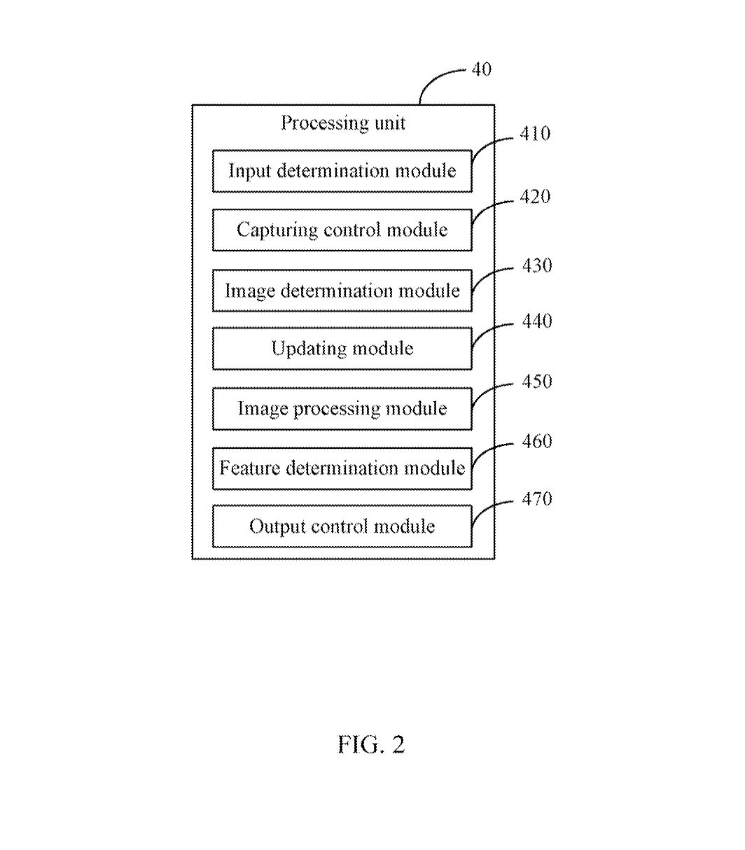

FIG. 2, shows the processing unit 40 including an input determination module 410, a capturing control module 420, an image determination module 430, an image processing module 450, a feature determination module 460, and an output control module 470.

The input determination module 410 determines whether an input instruction from the input unit 30 is received in the predefined time period from the timing unit 50 in the work state. When the input determination module 410 determines that an input instruction is received in the predefined time period in the work state, that means that there is a legal user operating the electronic device 1. When the input determination module 410 determines that an input instruction is not received in the predefined time period in the work state, that means that the user may have left the electronic device 1.

The capturing control module 420 controls the capturing unit 10 to capture a predetermined number of images when one input instruction is not received in the predefined time period in the work state. In one embodiment, the capturing control module 420 controls the capturing unit 10 to successively capture the predetermined number of images.

The image determination module 430 determines whether there is a facial image in the predetermined number of images. In one embodiment, the image determination module 430 determines an image having facial contours as the facial image. When there is not a facial image in the predetermined number of images, that means that there is no user in the front of the electronic device 1. When there is a facial image in the predetermined number of images, that means that there is a user in the front of the electronic device 1.

The image processing module 450 performs an image processing for the facial image to obtain a facial feature of the facial image when there is a facial image in the predetermined number of images.

The feature determination module 460 determines whether one of the at least one facial feature in the storage unit 20 matches with the facial feature of the facial image in the predetermined number of images.

The output control module 470 locks the electronic device 1 when there is no facial image in the predetermined number of images, and controls the electronic device 1 to maintain the work state when one facial image whose facial feature matches with one of the at least one facial feature in the storage unit 20, and locks the electronic device 1 and sends information to a legal user of the electronic device 1 when no facial image whose facial feature matches with one of the at least one facial feature in the storage unit 20. The information contains that an illegal user is operating the electronic device 1 and the facial image of the illegal user. The legal user of the electronic device 1 is predetermined.

Furthermore, the storage unit 20 stores parameters of each facial feature. The feature determination module 460 analyzes the facial feature of the facial image to obtain the parameters of the facial feature of the facial image and compare the parameters of the facial feature of the facial image with the parameters of the stored at least one facial feature. When all differences between the parameters of the facial feature and the parameters of the stored at least one facial feature are within a predefined range, one facial image whose facial feature matches with one of the at least one facial image in the storage unit 20.

Additionally, the capturing control module 420 further controls the capturing unit 10 to capture the predetermined number of facial images again after another predefined time period when no facial image whose facial feature matches with one of the at least one facial image in the storage unit 20.

Moreover, the electronic device 1 includes an updating module 440. The updating module 440 updates and stores the facial image in the storage unit 20 when one facial image whose facial feature matches with one of the at least one facial image in the storage unit 20. Therefore, the storage unit 20 stores an updated facial image corresponding to a legal user.

Also, the output control module 470 further records the facial image in the predetermined number of images and sends the facial image to notify the legal user of the electronic device 1 via an e-mail, a short message, or an alert ring tone. Therefore, the legal user can know who is operating the electronic device 1 via the sent facial image.

Therefore, when there is no user in the predetermined time period in the front of the electronic device 1, the electronic device 1 is locked to avoid an illegal user from operating the electronic device 1. When there is at least one illegal user in the predetermined time period in the front of the electronic device 1, the electronic device 1 is locked and the legal user is notified that another person is operating the electronic device 1. When there is at least one legal user in the predetermined time period in the front of the electronic device 1, the electronic device 1 maintains the work state.

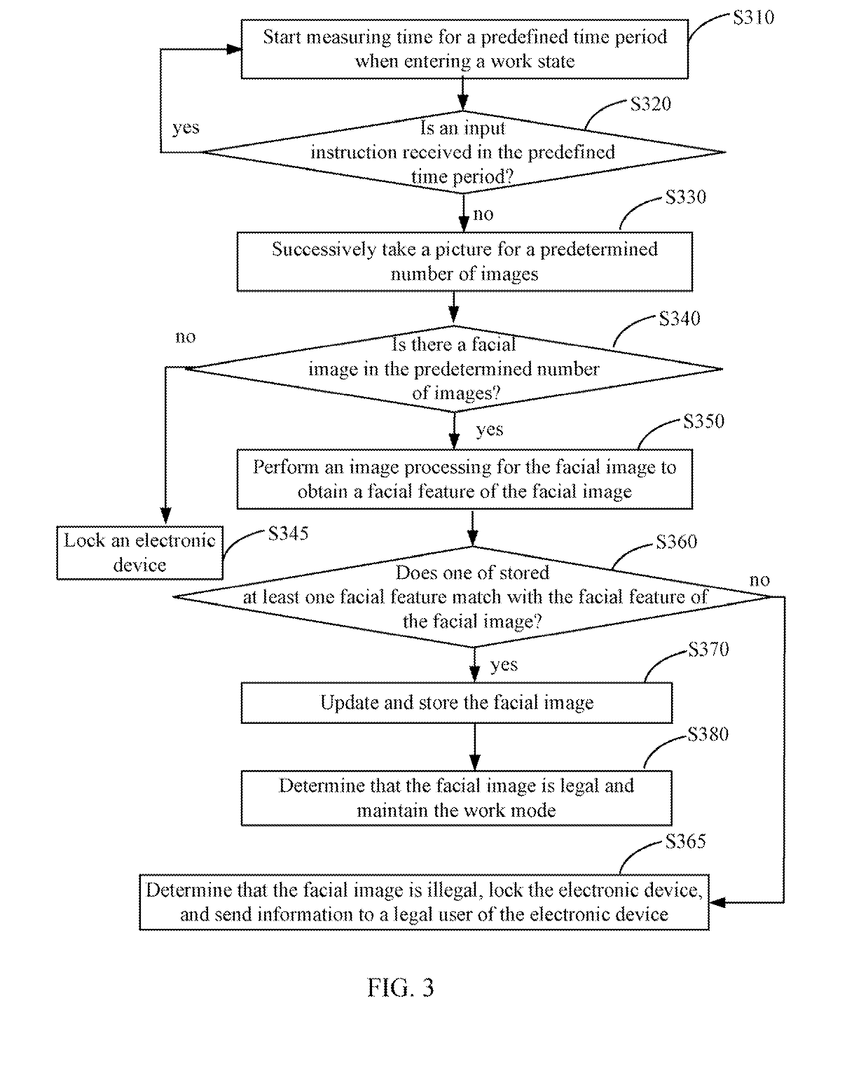

FIG. 3 is a flowchart of a method of monitoring the electronic device of FIG. 1, in accordance with an exemplary embodiment.

In step S310, the timing unit 50 starts measuring time for a predefined time period when the electronic device 1 enters a work state.

In step S320, the input determination module 410 determines whether an input instruction from the input unit 30 is received in the predefined time period in the work state. When an input instruction from the input unit 30 is received in the predefined time period in the work state, the procedure returns step S310.

In step S330, the capturing control module 410 controls the capturing unit 10 to successively capture a predetermined number of images when one input instruction is not received in the predefined time period in the work state.

In step S340, the image determination module 430 determines whether there is a facial image in the predetermined number of images.

In step S345, if there is no facial image in the predetermined number of images, the output control module 470 locks the electronic device 1.

In step S350, if there is a facial image in the predetermined number of images, the image processing module 450 performs an image processing for the facial image to obtain a facial feature of the facial image.

In step S360, the feature determination module 460 determines whether one of the at least one facial feature in the storage unit 20 matches with the facial feature of the facial image in the predetermined number of images.

In step S365, if no facial image whose facial feature matches with one of the at least one facial feature in the storage unit 20, the output control module 470 determines that the facial image in the predetermined number of images is illegal, locks the electronic device 1 and sends information to a legal user of the electronic device 1.

In step S370, if one facial image whose facial feature matches with one of the at least one facial feature in the storage unit 20, the updating module 440 updates and stores the facial image in the storage unit 20.

In step S380, the output control module 470 determines that the facial image in the predetermined number of images is legal and controls the electronic device 1 to maintain the work state.

Although the present disclosure has been specifically described on the basis of the embodiments thereof, the disclosure is not to be construed as being limited thereto. Various changes or modifications may be made to the embodiments without departing from the scope and spirit of the disclosure.

What is claimed is:

1. An electronic device comprising:
a capturing unit to capture images;
an input unit to generate input instructions in response to user's input;
a timing unit to start measuring time for a predefined time period when the electronic device enters a work state;
a storage unit to store at least one facial image and a facial feature of each of the at least one facial image; and
a processing unit comprising:
an input determination module to determine whether an input instruction from the input unit is received in the predefined time period in the work state;
a capturing control module to control the capturing unit to capture a predetermined number of images when an input instruction is not received in the predefined time period in the work state;
an image determination module to determine whether there is a facial image in the predetermined number of images;
an image processing module to perform an image processing for the facial image to obtain a facial feature of the facial image when there is a facial image in the predetermined number of images;
a feature determination module to determine whether one of the at least one facial feature in the storage unit matches with the facial feature of the facial image in the predetermined number of images; and
an output control module to lock the electronic device when there is no facial image in the predetermined number of images, and control the electronic device to maintain the work state when one facial image whose facial feature matches with one of the at least one facial feature in the storage unit, and lock the electronic device and send information to a legal user of the electronic device when no facial image whose facial feature matches with one of the at least one facial feature in the storage unit.

2. The electronic device as described in claim 1, wherein the image determination module is to determine an image having facial contours as the facial image.

3. The electronic device as described in claim 1, wherein the storage unit is configured to store parameters of each facial feature and the feature determination module is configured to analyze the facial feature of the facial image to obtain parameters of the facial feature of the facial image and compare the parameters of the facial feature of the facial image with the parameters of the stored at least one facial feature, when all differences between the parameters of the facial feature and the parameters of the stored at least one facial feature are within a predefined range, one facial image whose facial feature matches with one of the at least one facial image in the storage unit.

4. The electronic device as described in claim 1, wherein the at least one facial image is the facial image of authorized users.

5. The electronic device as described in claim 1, wherein the capturing control module is further to control the capturing unit to capture the predetermined number of facial images again after another predefined time period when no facial image whose facial feature matches with one of the at least one facial feature in the storage unit.

6. The electronic device as described in claim 1, wherein the capturing control module is further to control the capturing unit to successively capture the predetermined number of facial images when one input instruction is not received in the predefined time period in the work state.

7. The electronic device as described in claim 1, further comprising an updating module, wherein the updating module is configured to update and store the facial image in the storage unit when one facial image whose facial feature matches with one of the at least one facial feature in the storage unit.

8. The electronic device as described in claim 1, wherein the output control module is further configured to record the facial image in the predetermined number of images and send the information containing the facial image to the legal user of the electronic device via an e-mail, a short message, or an alert ring tone.

9. A method of monitoring an electronic device, the electronic device comprising a capturing unit, an input unit, and a storage unit to store at least one facial image and a facial feature of each of the at least one facial image, the method comprising:
starting measuring time for a predefined time period when the electronic device enters a work state;
determining whether an input instruction from the input unit is received in the predefined time period;
if one input instruction is not received in the predefined time period, controlling the capturing unit to capture a predetermined number of images;
determining whether there is a facial image in the predetermined number of images;
if there is no facial image in the predetermined number of images, locking the electronic device;
if there is a facial image in the predetermined number of images, performing an image processing for the facial image to obtain a facial feature of the facial image;
determining whether one of the at least one facial feature in the storage unit matches with the facial feature of the facial image in the predetermined number of images;
if one facial image whose facial feature matches with one of the at least one facial feature in the storage unit, controlling the electronic device to maintain the work state; and
if no facial image whose facial feature matches with one of the at least one facial feature in the storage unit, locking the electronic device and send information to a legal user of the electronic device.

10. The method as described in claim 9, further comprising:
determining an image having facial contours as the facial image.

11. The method as described in claim 9, wherein the storage unit is configured to store parameters of each facial feature, further comprising:
analyzing the facial feature of the facial image to obtain parameters of the facial feature of the facial image;
comparing the parameters of the facial feature of the facial image with the parameters of the stored at least one facial feature; and
if all differences between the parameters of the facial feature and the parameters of the stored at least one facial feature are within a predefined range, one facial image whose facial feature matches with one of the at least one facial image in the storage unit.

12. The method as described in claim 9, wherein the at least one facial image is the facial image of authorized users.

13. The method as described in claim 9, further comprising:
controlling the capturing unit to capture the predetermined number of facial images again after another predefined time period when no facial image whose facial feature matches with one of the at least one facial image in the storage unit.

14. The method as described in claim 9, further comprising:
controlling the capturing unit to successively capture the predetermined number of facial images when one input instruction is not received in the predefined time period in the work state.

15. The method as described in claim 9, further comprising:
if one facial image whose facial feature matches with one of the at least one facial image in the storage unit, updating and storing the facial image in the storage unit.

16. The method as described in claim 9, further comprising:
recording the facial image in the predetermined number of images and sending the information containing the facial image to the legal user of the electronic device via an e-mail, a short message, or an alert ring tone.
